(19) United States
(12) Patent Application Publication
(10) Pub. No.: US 2022/0191003 A1
(43) Pub. Date: Jun. 16, 2022

(54) Complete Tree Structure Encryption Software

(71) Applicant: Tamas Mihaly Varhegyi, (US)

(72) Inventor: Tamas Mihaly Varhegyi, Monroe, NC (US)

(21) Appl. No.: 17/643,811

(22) Filed: Dec. 10, 2021

(51) Int. Cl. H04L 9/06; G06F 16/901

(52) U.S. Cl. CPC H04L 9/0618; G06F 16/9027

(57) ABSTRACT

A software tool encrypting a plaintext and a password into a positive integer. The encryption algorithm uses an unlimited, symmetrical, virtual tree, where each element is associated with a single character, a story and a positive decimal integer. To obtain the original plaintext, the integer cipher text is deciphered into a legible text, using the same password and a complementary deciphering algorithm. The generation of an integer cipher text instead of a character one, vastly increases the difficulty of breaking the message, as the pre-arranged secret alteration of integer cipher text by the communicating parties is easily accomplished.

### BACKGROUND OF THE INVENTION

Most tree-structure literature deals with cases which do have concrete representation in memory. Actual physical links must be created and maintained, while at the same time sufficient storage must be provided for the mushrooming nodes. That is inevitable when the data is subject to arbitrary manipulation such as insertion, deletion, modification and random access search operations. These tasks are increasingly difficult to perform as the volume of the data increases.

Even in theory the general N-ary trees are handicapped by insufficient storage and slow execution times. But what eventually dead-ends all practical implementations beyond a certain size is cognitive overload.
That would happen when the designers have to face insurmountable algorithmic tasks. For example locating the beginning and end of a story, deletion and re-insertion at new locations and sizes is quite challenging. Unused memory fragments could not be easily removed causing bottlenecks both in memory storage and in execution times.
The total number of stories are prohibited to increase beyond practical limits. Engineers who have to deal with tree structure management issues are well aware of the challenges in this area.

I considered the feasibility of implementing data storage and manipulation with exceptionally large theoretical limits. The hope was to be able to handle data by simply writing a few lines of code without re-balancing trees or having to deal with garbage collection and other issues. In order to avoid these tasks it would require the knowledge to handle complex algorithmic challenges. That was a tall order. But fortunately one day, when browsing through a relevant piece of literature I came upon a diagram: see FIG. 1

The rest is history. A shockingly capable, yet exceedingly simple encryption utility was born.

### BRIEF SUMMARY OF THE INVENTION

This invention is a novel encryption utility software with virtually limitless ability to handle very large scale data encryption tasks in the tens of thousands of characters It consists of 4 procedures, two of which processes strings and two accepting lists.
Each kind has two algorithms implemented as software utilities using the Maple algebraic development software. The first is executed by the sender, it takes a password and a story to be encrypted, then produces a single positive decimal integer.
The password and the integer value is transmitted by the sender to the recipient who has the identical software utility. The recipient then takes the password and the integer produced at the sender's site submits it into the matching deciphering algorithm and retrieves the original story.

### DETAILED DESCRIPTION OF THE INVENTION

One example of a mention of a partially filled-in structure is shown in FIG. 1. It is called a “Near Complete Ternary Tree” (because the first level does not have a multiple of 3 nodes). As shown, each level has 3\hat{ }(L−1) elements (1, 3, 9, 27, . . . and so on) Each node also has 3 children (for space constraints the 4-th level was not filled in completely)
Also note that each element was assigned consecutive integers from left to right then down.

After some brainstorming I created a special Complete Tree Structure or CTS by making the following design choices: The first level has 3 nodes !!!

The CTS requires zero physical storage while offering unlimited virtual one. Even better, only a few algorithms manage both the deposit and retrieval of arbitrary-length stories. Next, I decided to settle for an organized collection of data with a trivial structure and rules.

When experimenting with depositing characters into the CTS, it became obvious that stringing together characters in the vertical direction made the most sense. So I generated stories by starting at any node at the top level then travelling downward through arbitrary imaginary links while collecting items from one solitary node at each level I visited. There was going to be no limit to a number of levels one could visit.

Thus, from the Near Complete Ternary Tree, with some modifications, a virtual Complete Tree Structure (or CTS for short) was born.

It is imperative to keep in mind that the single alphabet defined at the top level must be replicated without fail on all subsequent levels. That decision is what elevated the Complete Tree Structure to become a limitless repository of unique stories, including the generation of encrypted texts at will.

You might stand up and salute in awe. The endless (which some might call unnecessary) repetition of a stationary, once-defined alphabet will spread out and will form the backbone of all the stories which mankind or aliens could ever dream up, for any given alphabet.

Design Parameters of the Complete Tree Structures or CTS

A Complete Tree Structure or CTS is a virtual data repository. It contains an unlimited number of identical copies of an alphabet and manipulated by its associated access algorithms

The quintessential property of the CTS, that it is the virtual repository of all possible texts (called stories from now on) which can be composed using any or all of the characters of its defining alphabet.

In addition, if we confine ourselves to alphabets which contain only unique characters, it is guaranteed that each such story will appear only once in the vast virtual landscape of the CTS. Thus one-to-one correspondence between the integers and the stories will be maintained.

When the CTS is pressed into service as the backbone of the encryption utility, the uniqueness of the alphabet's characters is not necessary, as long as the alphabet can accommodate the stories we encrypt. That is, the story must use only the characters which exist in the alphabet !!!

The start and end nodes and all the nodes between them define the contents of the entire story. Amazingly, it is a trivial task to virtually tag each and every node with a unique, incrementing integer sequence number, or ISQN for short.

From the guaranteed dual uniqueness of the stories and the ISQN's it follows that there is perfect one-to-one correspondence between the stories and ISQN's. That is Each integer represents a unique story and no two stories resolve to the same integer (ISQN).

FIG. 2 This would be an appropriate place to list all possible 1, 2 and 3 character stories which the 3-character alphabet of (0, 1, 2) accommodates. The alphabets in this tree are defined by the numerical values which are deposited in the ovals on the very first level. Next, each letter of this alphabet spawns the exact duplicate of this alphabet.

Thus the Complete Virtual Tree is nothing more and nothing less than an endless list of faithfully reproduced alphabets. Associated with every single letter of every alphabet is one unique positive integer we call an Integer Sequence Number or ISQN. The ISQN's start at 1 and increment by 1 virtually indefinitely.
Very important: in this fundamental CTS housing an arbitrary length of fundamental alphabets such as (0,1,2) or (0, 1, 2, 3, 4, 5, . . . 72) and so on. To repeat, each item is tagged by a unique integer or ISQN. It is this association which enables us to generate stories containing an arbitrary number and sequencing of characters. Each and every such story will be “counted by” or associated with a unique ISQN.
The bedrock of the entire algorithmic enterprise rests on the predictable story which is always (0,1, . . . ,n) and a single integer value associated with each integer within ovals.
You will agree that stories which use only the digits from 0 to 9 would be very boring.
List of 1, 2 and 3 character stories generated by the alphabet “012”:
Single letter: 0, 1, 2
Two letters: 00, 01, 02, 10, 11, 12, 20, 21, 22
Three letters: 000, 001, 002, 010, 011, 012, 020, 021, 022,
100, 101, 102, 110, 111, 112, 120, 121, 122,
200, 201, 202, 210, 211, 212, 220, 221, 222

Next, we extend the usual character-based alphabets to a list based numerical variety. This becomes very useful when various national alphabets must be accommodated. We simply convert any non-English character set to a list of integers and we are good to go. Ultimately the commercially available CTS encryption utilities should be implemented using the local character sets in addition to the universally accepted ASCII set of English.

Finally we can unveil the primary purpose, the useful implementation of the CTS, which will let us write encryption utilities completely independent from the picture based ASCII character sets (whatever the extensions might be).

Then, the numerical values can be converted back and forth between an arbitrary set of non-numerical symbols serving a human interface and the well known integers accommodating the encryption algorithms. We get the best of both worlds.

The World Of Complete Tree Structure Encryptions

Given an arbitrary text, which we will call a story, written in a specific ASCII alphabet, we are guaranteed to be able to produce an associated unique ISQN value. This value will be the encrypted equivalent of the story.

The inverse dependency also holds: For any ISQN value produced with a given alphabet and a story, we can generate one and only one story, written in the given alphabet.

Replace the word “alphabet” with “password” and we arrive at the basic theoretical foundation of a very capable novel encryption utility.

It is my hope that this encryption method will find a place in practical applications in every corner of our society, whether a collection of sensitive personal information (SS#, driver's license, credit card numbers, address, phone numbers, date of birth, annual salary, medical history) or where megabyte to larger-sized industrial or military documents need to be protected.

Implementation Specifications and Details

The alphabet is the only user-definable property of the CTS
A CTS alphabet is fully defined either by a single list of positive integers
Example 1: (3, 43, 17, 1006) or a single string of characters,
Example 2: “abcdefgqrstwmdxy5432789AXQM35” or “B1mq0Xy7”

We denote the number of items in an alphabet with AS which stands for Alphabet Size. For the 3 alphabets AS=4 for the list and AS=29 and 8 for the string variety.

When the alphabet is explicitly defined, the uniqueness of its elements is neither guaranteed nor required. Its contents are entirely up to the users of the encryption utility.

The contents of a CTS alphabet is deposited into virtual nodes. Each node must contain exactly one item selected from the current alphabet. CRITICAL: The arrangement of the individual items of the alphabets must be identical to the order in which those items were defined in the alphabet at the first level.

A virtual CTS is created by theoretically linking an arbitrary number of nodes in an organized sequence. Nodes reside on levels denoted by L and are numbered from 1 to Lmax. The number of levels is unlimited and it is not related to the alphabet size AS in any way.

The first level of the CTS is constructed by a list of unconnected of nodes which cumulatively contain exactly one instance of the entire CTS alphabet, with the item order maintained.

This is a good time to state that all mentions of nodes connecting items is only for the purpose of understanding the structure, the order and the direction of travel within the virtual CTS. Such links or nodes DO NOT EXIST. However the imagined nodes, the arrangement of the levels, the purpose of traversing the CTS all serve one fundamental purpose.

The steps which generate either integers or strings were designed by the rules which are enforced by the virtual links. This single statement holds the secret of the efficient and foolproof encryption algorithms. Let us continue:

Nodes on the first level have outgoing links only.
Each node of the alphabet spawns and is linked to an identical alphabet which is positioned in the next level below. Important: All links are vertical.
With the exception of the first-level nodes, each node is connected to a single node above it and an Alphabet Size or AS-worth-of nodes below it.
In the CTS shown in FIG. 3, AS=3 with the alphabet of: “CBA”
Each of the 3 nodes contain a single character from the alphabet.

Traversing the CTS is only possible by moving through the links from level 1 through level Lmax, visiting exactly one node on each level (in order of its level number L).

Each node is assigned a unique, non-zero integer we named as Integer SeQuence Number, or ISQN for short. In turn, every ISQN designates exactly one node in the CTS. The numbering of nodes proceeds from the top level (L=1) down and within a given level from left to right.

Since every node contains a complete story, there will be a strictly enforced one-to-one correspondence between each node, the story which terminates at that node and the ISQN which locates that node.

A story is formed by concatenating the contents of the nodes we visit starting on the first level, and may end at an arbitrary node on any level including the top level.

The order we visit the levels is always downward, NEVER SIDEWAYS.
In addition, skipping the levels is prohibited !!!
When constructing a story we only select exactly one node on each level we visit.
Note: If the story ends at the top level it will be a boring single character story, albeit a valid one.

The story is completely defined by its terminal node. Please note that there are an endless number of stories which originate from any of the nodes on the first level, but the story's terminal node is occupied only by the last character of one and only one solitary story.

Critical observation: If we permitted starting a story from any node on any level there would be an obvious and inevitable way to generate an unlimited number of exact duplicates of each story. That would end all hope for a useful, manageable application.

There are no actual memory traversal algorithms at all. Instead, we associate a story character with a unique ISQN at each and every node in the tree. There is a well-defined relationship between the contents of each node and the location of the nodes. For every story and alphabet pair submitted to the encryption utility there is always one and only one computable ISQN value.

The story and the alphabet defines the ISQN, while the ISQN and the alphabet defines the story.

Hopefully we have sufficiently described the intent, the structure and the contents of the virtual Complete Tree Structure

Amazingly this virtual (therefore non-existent) structure is eminently suitable to serve as a backbone for two algorithms. The first will enable us to deposit a story of virtually any size, written in a given ASCII alphabet, into the CTS.

The location of the node is uniquely determined by the contents of the story and the alphabet. This location will be returned to the user as a single positive decimal integer, the ISQN. The second algorithm will obtain a complete story for a given ISQN and alphabet

Reminders and Reinforcements:

1. The CTS does not require actual storage (no memory management, rebalancing trees etc.)
2. Complex recursive navigation procedures are not needed.
3. The access algorithms are extremely simple and powerful.
4. The CTS presents an unlimited virtual storage to users.
5. The CTS accommodates the fundamental data types of integers and ASCII characters.
6. The CTS uses two data structures: strings of characters and lists of integers
7. Stories are not explicitly stored. They are generated by using extraction algorithms

Kinds of Inputs the CTS Algorithms Take:

A single integer specifying the Alphabet Size or AS value of the CTS
A list of comma-separated integers: for example: (1, 7, 3, 0, 15) (AS=5)
A string containing characters of the alphabet, e.g.: “F9xMght@” (AS=7)
The integer sequence number (ISQN) of the terminal node where the story ends.
That in a nutshell is all the design specification we need to deposit or retrieve stories from any CTS structure with a given alphabet.

Notes:

In the encryption applications which are the mainstay of this patent, (with the alphabets of the CTS assuming the role of the encryption passwords) the users are free to specify duplicate characters in the passwords. Not only are they permitted but by lengthening the password, these actions might enhance the resistance of the encoded messages to attempted hijacking.
CAUTION: When the alphabet is explicitly defined, the uniqueness of its elements is decided by the users who specify the contents of the alphabet. If they chose an alphabet with duplicate elements they must be aware the consequences and act accordingly.

Other Features and Tactics:

1. Passwords can be arbitrarily bloated, containing duplicate or not-needed characters.
2. After the initial password is agreed upon during a secure, preferably in-person exchange, alterations to subsequent passwords could be embedded in the “story” file itself.
3. Hybrid (text and integer) passwords could encode the numerical message again.
4. Language independent. Only the ASCII equivalent of the local symbols (e.g. Russian, German) must be defined. The encryption algorithms remain the same.
5. A number of completely gibberish messages could be transmitted, before one bona-fide consequential message is sent.
The patterns would be indistinguishable. as a very long integer would be sent each time.
The recipient would know which one is the genuine one and would not waste time deciphering the fakes. At the same time the attacker would have to search every one, without ever knowing whether the effort expanded on the message did or did not contain the critical information.
6. We already mentioned that the alphabet is a collection of ASCII characters, or characters belonging to any character set. We however must be stated t unequivocally that the passwords are defined by the sender of the encrypted message. A password is always created from the subset of the alphabet. This subset might permutated, extended by duplicate characters and so on.

A Working Example in Maple 2018

A sequence of encrypting then deciphering a message encoded with a given password
password:=“abcdirTeghsltuvfwnxoypz ABCDVWXYZ.:012378$9”;
plain-message:=“The price of gas went down to $2.38”;
secret_message:=encrypt_string_pwd (plain_message, password):
secret_message:=249745488975647551056069102518871872882399755262625669888;
plain_message_back:=decipher_string_pwd (secret_message, password);
plain_message_back:=“The price of gas went down to $2.38”;
IMPORTANT: The characters used in the plain message must exist in the password !!!

Although my method will not replace a current crop of sophisticated and nearly unbreakable algorithms, I believe that it would find a significant niche eventually. One advantage is already obvious: The size of the plain text to be encrypted is practically unlimited and is constrained only by the hardware resources the algorithm is executed on.

Very important: The CTS access algorithms are a worthy exploitation of the CTS structure. By all measures their complexity ranks near the bottom and are easily implemented on virtually all hardware and software platforms.

Two elementary procedures perform the conversions to and from stories to integers and back. All derivative utilities spring from these algorithms, which can be described in a single page. I designed the encryption algorithms with the goal of being able to accommodate arbitrary alphabets. However, I focused on a single language English implementation.
In retrospect, concentrating on the quintessential algorithms was a good decision.
After all, the users, in their specific countries or particular application spheres will be quite capable of designing custom alphabets and adapt them to the core CTS access algorithms. This is greatly aided by the Maple algebraic prototyping utility. published by Maplesoft of Ontario Canada

Additional Claims of the CTS Encryption Scheme

1. Its extreme ease at which the two parties can customize the encryption on the fly. This means that the intruders would have to expend disproportionate amount of effort of intercepting messages which may or may not even hold any profitable secrets.
2. The alteration of the passwords at the decoding site using publicly available alphanumerical data (e.g. sports scores, temperatures, stock market closing, dictionary entries, YouTube videos and so on) would also make it nearly impossible to break the code.
3. Since the encrypted message is always numerical, it could be altered by simple arithmetical operations using unpredictable integer values and basic operators such as multiply, add, switch, remove as well as an endless esoteric rotate etc). These alterations could be communicated at previously agreed intervals independently of the transmission of the encrypted text.
4. Passwords unexpectedly scrambled using random number generators, and sent embedded in the main message would put the likelihood of breaking a message practically out of reach.
5. Because encoding and decoding is not exceptionally time or power consuming, one could afford to send an unpredictable series of gibberish messages, which would have zero coherent content. Eventually the critical message would be transmitted.
Notes: in FIG. 5 and FIG. 6 we demonstrate alternate alphabets
In FIG. 5 we have an exclusively numerical alphabet (7, 2, 3) arranged in a list structure.
In FIG. 6 we show an alphabet “ABA” to indicate that duplicate letters are allowed.
There is also a vast variety of combinations and permutations of letters, numbers, special characters of the ASCII alphabet which can be deployed as alphabets.
Other national alphabets could be also accommodated, but that would require a local implementation of such alphabets. However, in the current implementation only the US ASCII character set and the positive decimal list structure is supported.

FIG. 4 This would be an appropriate place to list all possible 1, 2 and 3 character stories which a particular virtual tree defined by the 3-character alphabet of “CBA” accommodates.

List of 1, 2 and 3 character stories generated by the alphabet “CBA”:up to ISQN=40
Single letter stories: C, B, A,
Two letter stories: CC, CB, CA, BC, BB, BA, AC, AB, AA,
Three letter stories: CCC, CCB, CCA, CBC, CBB, CBA, CAC, CAB, CAA,
BCC, BCB, BCA, BBC, BBB, BBA, BAC, BAB, BAA,
ACC, ACB, ACA, ABC, ABB, ABA, AAC, AAB, AAA
   Note: First four letter story: CCCC (at location 40)
Last four letter story: AAAA (at location 120)

Conclusion:

There are no 100% safe encryption algorithms. After all, a personal attack upon either of the communicating parties would break the encrypted message in a hurry. (That would have to be counteracted by denying access to the critical messages by human handlers.) However, I believe that the primary goals as listed has been achieved in spades !
Enabling the transmission of vast amounts of encrypted texts.
Providing an incredibly low cost readily available encryption utility.
Accommodating a wide range of custom made tools to fit the particular applications.
Making the code breaking both financially and with respect to timeliness prohibitive
The encrypted information is in the form of a single positive integer, which is suitable for further customized alteration which is either pre-agreed or post-transmitted.
The key is an entire ASCII alphabet, or a list of integers. The alphabets can be extended by using private symbols. However I believe that the 256 letter extended ASCII will be sufficient.
Using the list of integers instead of ASCII or other language alphabets has another advantage. It completely removes the association between the encrypted integer value and any human text based alphabet used by humans. Familiar “frequency of characters” use in a particular story is removed as a possible last clue which could aim the breach of the transmission.
Both the alphabet and the text to be encrypted can be extended considerably, if desired.
Can be used to encrypt vast amounts of sensitive industrial or military text on a daily basis. These encrypted integers can be conveniently stored for future retrieval.
The current encryption offerings are complicated and frequently limited with respect to the size of encrypted text. However, specialized encryption utilities do exist which are designed to process extreme volumes of sensitive data. I am only guessing that the price tag would be proportional. To best of my knowledge, there is no comparable encryption utility currently available overall, with similar or better features to what is presented here.
Please don't hesitate to disagree, if that claim is wrong. I welcome and need expert feedback

Design Details of the [C, B, A] Complete Tree Structure (see FIG. 3)

On the following pages we will detail the procedures which perform the deposit and retrieval of the stories stored in virtual CTS.
We also present the general design principles of the fundamental virtual CTS.
In the fundamental CTS shown below, each node contains a single entity: a decimal integer ranging from 0 to AS−1, where the variable AS stands for Alphabet Size, which denotes the number of elements in the alphabet.

In our discussions we use an alphabet with 3 symbols: [C, B, A] with the numerical equivalent of [0, 1, 2]. Thus the values of the symbols are: C=0, B=1 and A=2 It is the decimal values associated with each letter of the alphabet which enable us to write exceptionally efficient and useful algorithms which access the Virtual Complete Tree Structure. We must keep emphasizing: there is no actual tree structure at all, the visible depiction only enables us to design and manage the interactions between a given node's theoretical ISQN and the integer value equivalent of the character string the node contains.

Then the details of the hierarchical structure and the associated strings stored can be demonstrated without being hampered by the sheer number of nodes. However the complete tree structure can be scaled up to an arbitrary size and may be used with any application-specific symbols set, such as [A, B, C] or [$, q, X, 7, 4] and so on.
This diagram of the ternary tree also serves to demonstrate the interdependence of counters, addresses, level numbers, single node contents and stories formed by linking an arbitrary number of nodes within a complete tree.

The nodes are depicted using ovals. Each contains one character of the alphabet In the current case: alphabet=[C, B, A], AS=3, thus a node can contain A, B or C.

The integer counters or ISQN's shown outside and to the left of the nodes determine the breadth-first position of the nodes. The ISQN's are assigned by starting at the leftmost node of the top level (L=1), sweeping to the right then descending to the next level. This way each and every node in the complete tree will be associated with a consecutive integer value.
The square boxes to the right (or below) of the nodes depict the strings which are the concatenations of the contents of the nodes which were visited by arriving at that node.

The contents of the strings formed that way constitute our stories. The construction of a story is always taking place depth first, starting from the top level and visiting any number of nodes from one level to the next moving downward, using the pre-determined links which must be defined prior of utilizing the complete tree.

How do we obtain the ISQN for a story which ends at any given node ? We start from the leftmost node on the first level, which has ISQN=1. Then we travel to the right and count all the nodes on the first level. We repeat this left-to-right scan of each node while counting the nodes we passed.
When we reach the level on which the node in question is, we count from the beginning of the node until we reach the node of interest. For example to get the ISQN for the story [1, 2, 1], we count 1 through 3 on the first level, 4 through 12 on the second and 13 through 29 until we reach the terminal node for [1, 2, 1]

There are Two Alphabet Structures Qualified by their Contents and Structure:

Case #1: Arbitrary integer alphabet contained in a list structure
Case #2: Arbitrary ASCII alphabet defined as a string
The Alphabet Size is either determined by the number of elements in the list or by the number of ASCII characters contained in the string
Note: Lists and strings define data structures used by various compilers, but both are an implementations of a mathematical entity called arrays.

Case Study #1 how to Obtain the Story which Corresponds to an ISQN:

1. We travel from left to right on each level, node by node, counting up by one until we reach the count equal to ISQN.
Then we start a list, and place the contents of the node we arrived at in it.
Next, we follow the up-links from this node all the way to the top-most level.
As we access each node on the way, we append its content to the list,
including the last story character on the first level.
The story is formed by the reverse of the list produced this way.

Example: With ISQN=32, we have to go all the way to the third level,

Location 32 is the 20-th node from the beginning of the level.
Once locating it we deposit its content to start the list=[1],
Next, follow the link to node 10 on the 2-nd level and append its content to the list to obtain [1, 0], Finally, follow the link up to node 3 on the first level and add its content to obtain the list=[1, 0, 2]. This must be reversed to obtain the story which terminates at location 32 namely [2, 0, 1]
Let's demonstrate two of the Maple algorithms which will test-drive the basic:
two-way story to —ISQN and ISQN—to—story conversions

3.6 Conclusion:

For those readers who have been designing algorithms which create, access, alter, and in general manage the wide variety of data structures, this must be a dream come true. Note, that in the software algorithms I implemented alphabets are either represented as integer lists or character based strings. Examples: [1, 8, 3] and “ab972$Zc9”
The CTS structure itself may accommodate alternate algorithms which would allow stories to originate from and terminate at an arbitrary level and node of the CTS. This however, would result in an unlimited number of duplicate stories while yielding no practical benefits. Even worse, it would destroy the exceptionally elegant and streamlined access utilities.

You should agree that the CTS algorithms as specified and implemented will guarantee that all possible stories using a given alphabet will be generated and generated only once. Thus, the decision to originate and anchor all stories in top level nodes was right !

There are two distinct “one-way” independent conversion algorithms:
1. Given any story and any alphabet, the algorithm returns the corresponding ISQN.
2. Given any ISQN and any alphabet, the algorithm returns its corresponding story.
These independent conversions become useful when executed in a specific order and for a very specific purpose.
For this patent submission only a “two-stage” round-trip conversion sequence will be discussed.
1. Given a story S and an alphabet A, return an integer ISQN
2. Using the integer ISQN and the same alphabet A, obtain the same story S

$${L}_{BEG} = \frac{{AS}^{L} - 1}{AS - 1} {L}_{END} = AS \frac{{AS}^{L} - 1}{AS - 1}$$

This, is the conversion sequence of an encryption/deciphering application.

$${L}_{BEG} = \frac{{AS}^{L} - 1}{AS - 1} {L}_{END} = AS \frac{{AS}^{L} - 1}{AS - 1}$$

Notes: It is guaranteed that the conversion will work even if the alphabet includes duplicate items.

$${L}_{BEG} = \frac{{AS}^{L} - 1}{AS - 1} {L}_{END} = AS \frac{{AS}^{L} - 1}{AS - 1}$$

L_{BEG} and L_{END} are the ISQN integer values for the nodes which begin and end a level respectively.

$${L}_{BEG} = \frac{{AS}^{L} - 1}{AS - 1} {L}_{END} = AS \frac{{AS}^{L} - 1}{AS - 1}$$

$${L}_{BEG} = \frac{{AS}^{L} - 1}{AS - 1} {L}_{END} = AS \frac{{AS}^{L} - 1}{AS - 1}$$

The number of stories or a given level or Level Size LS with alphabet size=AS and L is: L_{S}=L_{END}−L_{BEG}+1=AS^{L}

Alphabet Size, AS = 3 Length = L = 3
(Assume the implied alphabet of [C, B, A])
maximum ISQN = 39

### FOR AS=3

| L | L_{BEG} | L_{END} | L_{SIZE} |
|---|---|---|---|
| 1 | 1 | 3 | 3 |
| 2 | 4 | 12 | 9 |
| 3 | 13 | 39 | 27 |

3. Trace the procedures which implement the access algorithms:

Obtain the story, given the two known parameters:

### Alphabet=“CBA” and the Integer Sequence Number or ISQN=35

The story will contain some or all of the letters of the alphabet in a unique sequence.

$${L}_{BEG} = \frac{{AS}^{L} - 1}{AS - 1} 4.$$

From the Alphabet “CBA” we obtain the Alphabet Size, AS=3

$${L}_{BEG} = \frac{{AS}^{L} - 1}{AS - 1}$$

$${L}_{BEG} = \frac{{AS}^{L} - 1}{AS - 1}$$

From AS=3 we construct the implied Numerical Alphabet, NA=[0, 1, 2]

$${L}_{BEG} = \frac{{AS}^{L} - 1}{AS - 1}$$

$${L}_{BEG} = \frac{{AS}^{L} - 1}{AS - 1}$$

### Unknowns: SS=story_size and the AS_story

$${L}_{BEG} = \frac{{AS}^{L} - 1}{AS - 1}$$

Compute L_beg using the formula:

$${L}_{BEG} = \frac{{AS}^{L} - 1}{AS - 1}$$

Execute the loop:

$${L}_{BEG} = \frac{{AS}^{L} - 1}{AS - 1}$$

$${L}_{BEG} = \frac{{AS}^{L} - 1}{AS - 1}$$

while L_beg<=ISQN″ do

### L_beg=1 SS=1

### L_beg=4 SS=2

### L_beg=13 SS=3

### L_beg=40 SS=4

end while loop
We did overshoot !!! since L_beg=40 is greater than ISQN=35
Must back off !!!: Right values are: L_beg=13 SS=3

### Compute: Diff=ISQN−L_beg=35−13=22

Convert Diff to an AS base to obtain AS_story
reverse_story=convert (Diff, base, AS)

### Diff=22, AS=3

rev_story_digits=convert (22, base, 3)
rev_story_digits=([1, 1, 2])

### # Note: 1*3\hat{ }0+1*3\hat{ }1+2*3\hat{ }2=1+3+18=22

story_digits=reverse ([1, 1, 2]) to obtain [2, 1, 1]
Using the original alphabet [C, B, A], map [2, 1, 1] to [A, B, B]
convert 2, to the 3-rd letter A, finally, 1 and 1 to the second and third letters B each

Done: located at ISQN=35 in the CTS structure we find the AS_story=“ABB”.

############### The inverse process: ##########

From the known AS_story=“ABB” written in the Alphabet=“CBA” find the corresponding Integer Sequence_Number or ISQN

### Preliminary Algorithmic Steps:

From the Alphabet=“CBA” we obtain the Alphabet_Size, AS=Length (“CBA”) or AS=3
From the AS_story=“ABB” we obtain the Story_Size: SS=nops (ABB)=3
From the Alphabet_Size, AS=3 we construct the implied Numerical_Alphabet, NA=[0, 1, 2]
From the Alphabet=“CBA”, the Numerical_Alphabet=[0, 1, 2] and AS_story=“ABB”, we obtain the Numerical_Story or NS=[2, 1, 1];

Detailed Algorithmic Steps:

SS: =nops(story)=nops(ABB)=3; SS:=3;
From AS=3 we have the implied alphabet=[0,1,2], change it to [C, B, A] which is the alphabet residing on the first row of CTS going from left to right. rev_story:=ListTools[Reverse](story); /* using the built in Maple function

### DIFF:=0;

### L_beg:=(AS^{SS}−1)/(AS−1);

### L_beg:=(3³−1)/(3−1)=(27−1)/2=13

L_beg:=13 This is the ISQN of the leftmost element on the row which terminates the story ################################### work on this to get DIFF=35
for L from 1 to SS do
DIFF:=DIFF+rev_story[L] *AS^{L-1};
   end do;

### ISQN:=L_beg+DIFF;

# Below is the Maple output text:

rev_story=[0,1,2] [B, B, A] !!!! FIX

### DIFF:=0;

### L_beg:=13

### DIFF:=0

### DIFF:=3

### DIFF:=22

### ISQN:=L_beg+DIFF=13+22=35

ISQN:=35 We are done

### !!!!!IMPORTANT!!!!!

What makes this encryption algorithm universal is the design which allows any language or application specific alphabet to be mapped to a positive integer list. This ensures wide unencumbered use and also removes any link to a particular language which would allow a toe-hold of a cyber attack based on known language patterns.
For software engineers who design, create, populate and alter complex data structures which occupy vast amounts of storage space, the CTS design must come as a surprise to be regarded as an alien intruder into the wonderful world of endless memory management challenges.
Not only is the CTS virtual and unlimited, requires no memory, but it is designed to manipulate data sets which may contain the entire character-based output of our advanced civilization. This vast universal reach is accomplished within seven elementary Maple-18 procedures which I did not even had to compile link or host.
Maple did it, for that I expect some jealous comments from the software community.

Demonstrating Ease of Activating Extra Defense by Off Grid Means

alphabet_shared_but_hacked:=“AHBeClDxyzo wamhryu?”; #this gets hacked !!!
ISQN_alter_add:=55; #known off-grid to legitimate parties: temperature at 7 am
ISQN_alter_multiply:=736; #known off-grid to legitimate parties (3 digits of closing DJIA)
story:=“Hello how are you ?”;
ISQN_in:=encrypt_string_pwd (story, alphabet_shared_but_hacked);
#however sender will alter_ISQN_in according to a pre-arranged method ISQN_in_altered:=(ISQN_in+55)*736;
# this gets intercepted and used by hacker, thinking it is valid
story_obtained_by_hacker:=decipher_string_pwd (ISQN_in_altered alphabet_shared_but_hacked);
#legitimate recipient executes inverse of custom alteration previously agreed on in secret ISQN_in_recovered:=(ISQN_in_altered/736)−55;
legitimate_story:=decipher_string_pwd (ISQN_in_recovered, alphabet_shared_but_hacked);
#####################################
alphabet_shared_but_hacked:=“AHBeClDxyzo wamhryu ?”
ISQN_alter_add:=55
ISQN_alter_multiply:=736
story:=“Hello how are you ?”
ISQN_in:=1390959159387721089147912
ISQN_in_altered:=1023745941309362721612903712
story_obtained_by_hacker:=“BaCmewyeeerlxy oDy xw”
ISQN_in_recovered:=1390959159387721089147912
legitimate_story:=“Hello how are you ?”

Footnote#1:

The alphabets for each tree are defined by the sequence of letters on the top level: [0,1,2] for FIG. 2, [“C”, “B”, “A”] for FIG. 3, [7, 2, 3] for FIG. 5

### and [“C”, “B”, “A”] for FIG. 6

Subsequently each additional node spawns a replica of the complete alphabet again
Now, let's mention the single serendipitous idea which is the ultimate bedrock of the entire CTS and subsequently the encryption algorithms, which in turn are the single purpose of the entire Complete Tree Structure Encryption Software.
The idea is this: As the figures show, each node not only holds a single character of the alphabet but becomes the building block of a story, which always starts at the first level of the structure and terminates at each and every node.
The stories which are generated are depicted in the vertical blocks next to the last character of each story. The 3 stories in FIG. 3 are [C], [B], and [A] on the first level, the 9 stories are [CC], [CB], [CA], [BC], [BB], [BA], [AC], [AB], [AA] on the second level The last story shown on level 3 is [AAA]. Important: The generation of stories has never ends. Moreover, at the instant the fundamental alphabet is defined, all possible stories are also created. Now the obvious: As shown, each story is assigned a unique integer starting on the left on each level. The integers are 1, 2, 3 on level 1, continuing 4 through 12 on level 2 and 13 through 39 on level 3. The result of this incredibly simple association is that each and every story will be assigned a unique integer sequence number or ISQN for short.
The reverse is also true: Each and every integer will be assigned its very own story (which is not necessarily unique), but correctly identifying the story which resides at that ISQN. All figures depict a unique tree structure whose varieties in computer science and in working applications are well-known. I named them Complete Tree Structures or CTS for short.

Footnote #2: One salient property of the CTS is that it does not have a corresponding actual physical storage at all, it is only an idea, albeit an incredibly handy one.

Amazingly this ethereal CTS fulfills a mission which is in my opinion a miracle already, but it also assists with the design and implementation of a pair of exceptionally useful encryption and deciphering algorithms.
In the CTS each cell contains a single letter. A collection of a sequence of letters is called an alphabet. Please observe, that the top level always has a single copy of the alphabet. On subsequent levels, every letter of every alphabet will spawn another complete alphabet.
This is how the CTS is generated. The particular roll out of the CTS with the endless duplication of the defining alphabet is entirely conceptual . . . it does not exist at all. However this arrangement of the virtual CTS performs the near impossible. It enables us to locate each and every character in the CTS. Locating a character does not produce a physical location but a single positive integer. The inverse operation finishes the loop. Writing suitable algorithms we can take any positive integer, locate it in the CTS pyramid, then travel toward the first level collecting the contents of each. That action gives us back the one and only one unique story which belongs to the integer which we used to blaze a trail.

Footnote #3:

The examples of valid alphabets are intentionally trivial in order to demonstrate their use. However in actual use the alphabets could be hundreds of characters long, containing arbitrary compositions, ordering and repetitions. For example:
“394839ujdjdlfjwelr3−456−4=6=4+++!!!!!!!fjdf3e9nklj1391873209jncwdo3uy399999999” would be a CTS where 77 characters repeat in tandem indefinitely on each level. These 77 characters also define the alphabet from which an endless number of stories could be constructed.

Footnote #4: In the current version the terminating character of a double quote (″) cannot be used within the alphabet for software design considerations. However Maple has a nice feature which uses a special character to force the software to ignore embedded double quotes and recognize only the two outermost double quotes as terminating either the alphabet or the story.

### BRIEF DESCRIPTION OF THE SEVERAL VIEWS OF THE DRAWINGS

FIG. 1: demonstrates a Near Complete Ternary Tree Structures.
Credit: Common domain from the internet
What makes this arrangement incomplete is that the number of nodes on the first level is not an integer multiple of 3. Note of Copyrights: There are numerous postings which depict the drawing I show in FIG. 1, however they claim it to be Complete Ternary Trees and such. That is one choice of labeling, however I modified the structure to make it truly complete. But the point is moot as I defined a Complete Virtual Tree Structure, where the number of nodes on the first level are duplicated indefinitely. Regardless, binary, ternary and other structures were in common domain probably for a century or more in the mathematics literature. As you will see I made the most of it.
FIG. 2: demonstrates a Complete Virtual Tree Structures (CTS for short) where each node contains the letters of a pre-defined numerical alphabet [0, 1, 2] together with an associated positive integer sequence 1, 2, 3, . . . 39 which is a subset of a natural counting order 1, 2, 3, . . . n, where n is an arbitrarily large integer

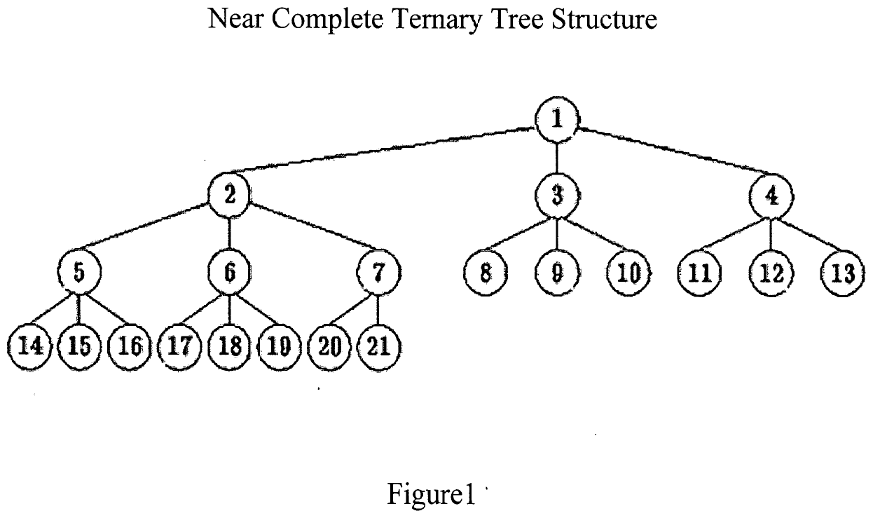

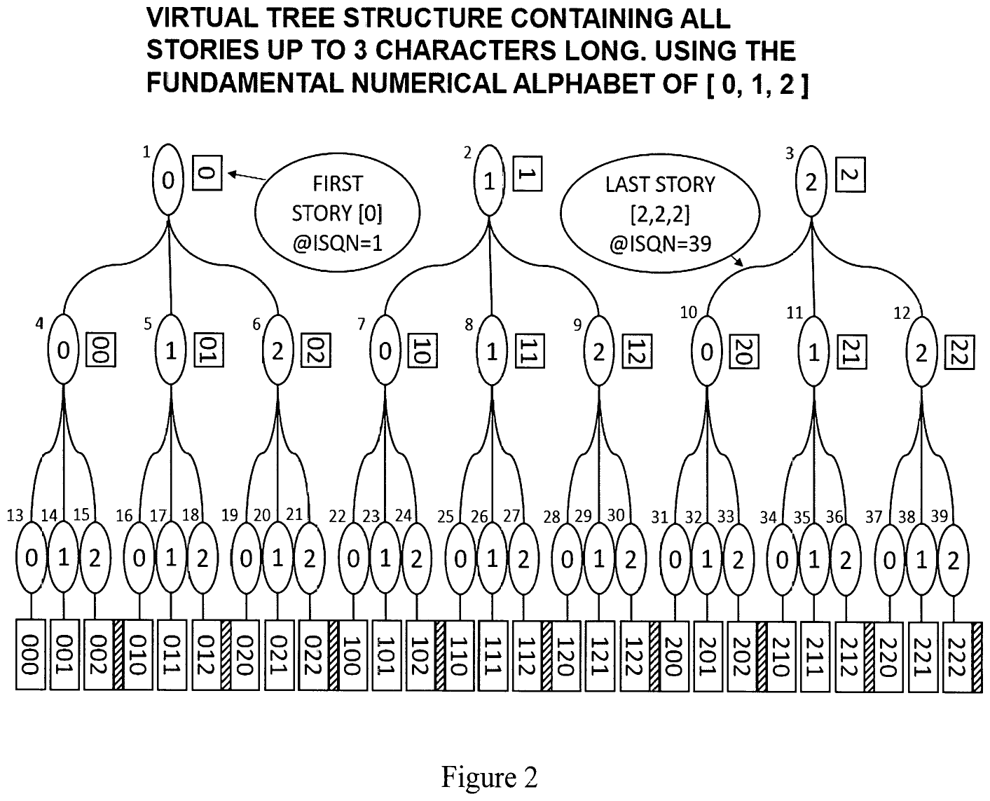

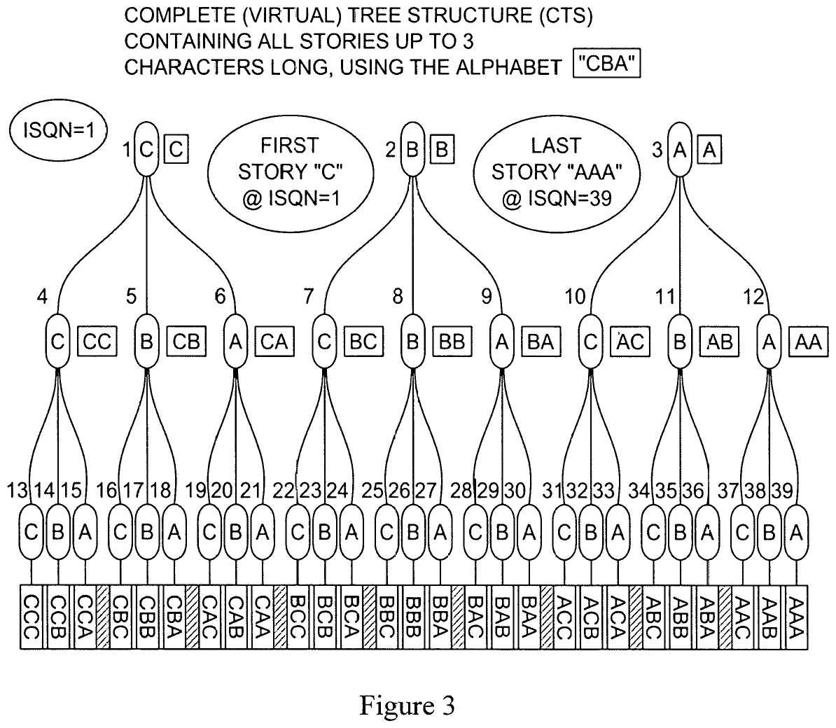

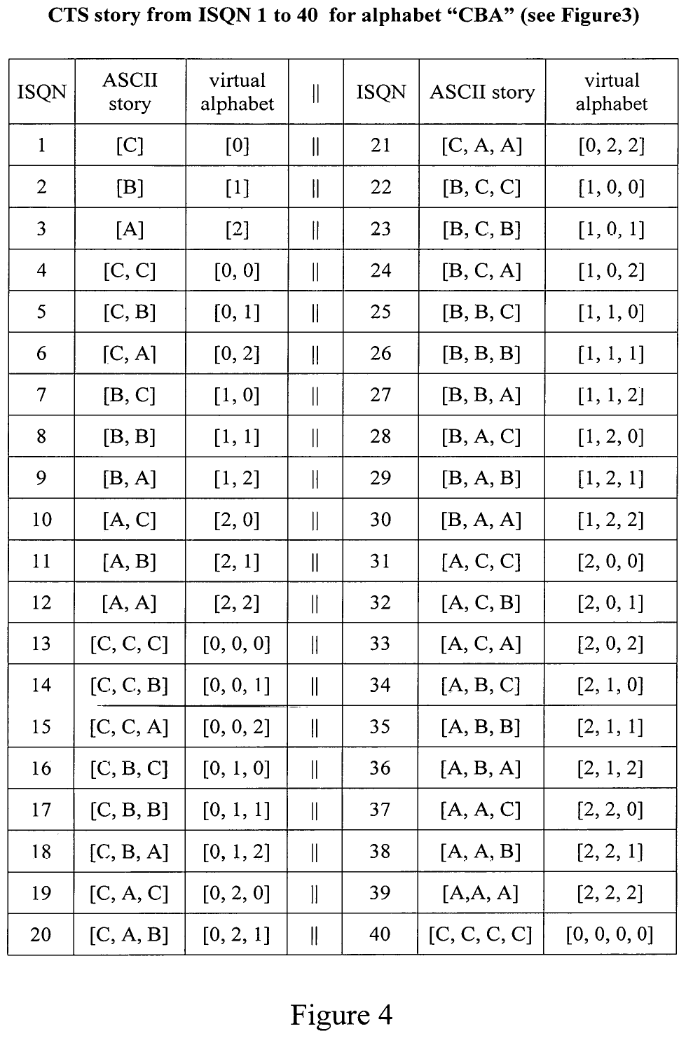

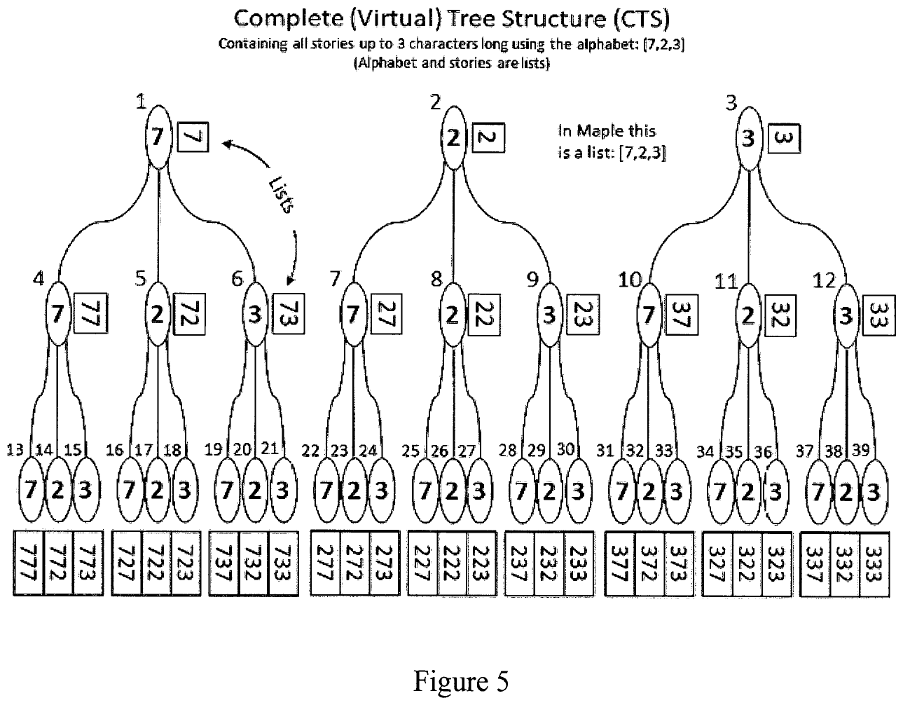

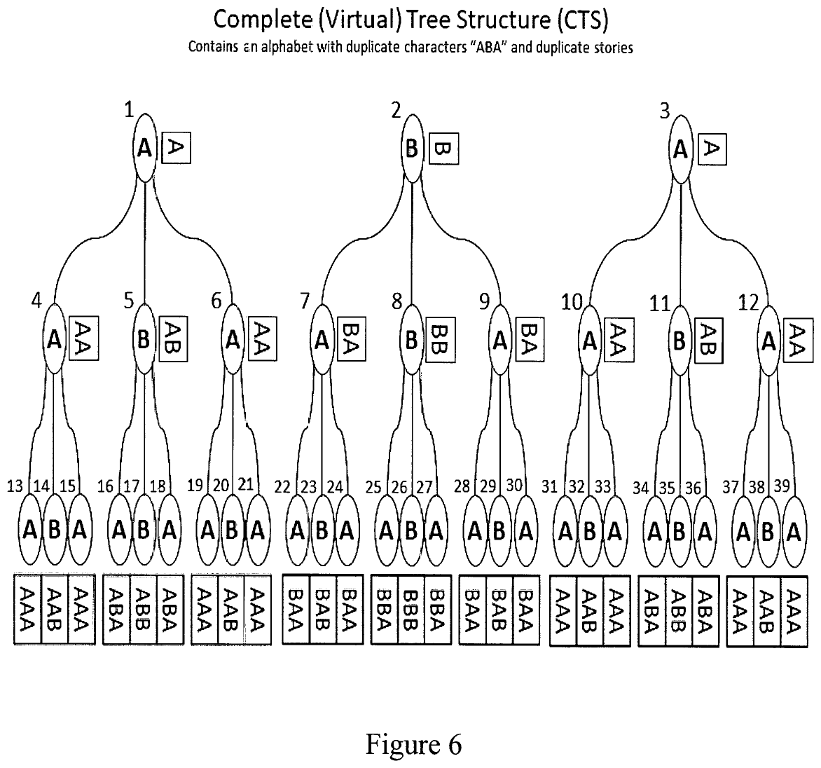

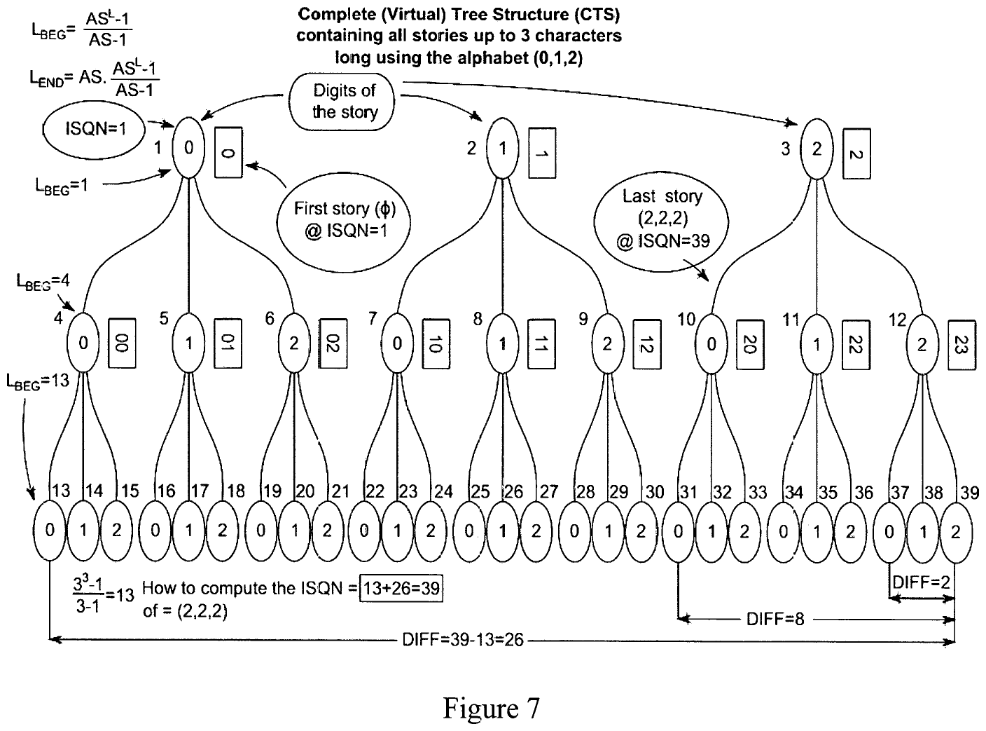

### Credit: Aron Varhegyi, my son

FIG. 3: Demonstrates an alphabet [C, B, A] whose letters are arranged in an arbitrary order.

### Credits: RAHUL RANA (SAGACIOUS IP)

FIG. 4: Shows the stories up to length 3, which can be generated by the alphabet [C, B, A].
FIG. 5: Demonstrates an alphabet which is defined in a numerical list of [7, 2, 3] instead of ASCII characters of the ASCII table. Using integer lists for an alphabet facilitates a complete freedom from any national alphabet. All stories written would be stored in an integer list, instead of using a string of characters. The lists then could be translated to and from the particular national alphabet.

### Credit: Aron Varhegyi, my son

FIG. 6: We demonstrate that an alphabet may contain duplicate characters in any order.
For example: [“A”, “B”, “A”]

### Credit: Aron Varhegyi, my son

FIG. 7: Gives a brief insight on how the Integer Sequence Number or ISQN is computed for a given story written in a given alphabet. The recipient then takes the ISQN and the alphabet and reconstructs the story by collecting the characters of the password from the ISQN all the way up to the first level.

### Credit: RAHUL RANA (SAGACIOUS IP)

1. A theory of a computer algorithm comprising:
(a) A novel method of encrypting arbitrary length plaintext and a password into a positive integer while an encryption algorithm uses a virtual tree, where each element is associated with a single character, a story and a positive decimal integer.
(b). The algorithm at the transmitting site obtains the original plaintext and a password then generates a cipher text which is a single positive integer of arbitrary length, while the algorithm at the receiving site uses the same password and the single positive integer and produces the original plaintext identical to the plaintext at the transmitting site.
(c). The generation of an integer cipher text instead of a character one vastly increases the difficulty of breaking the encrypted messages, while this patent application is backed up with a fully developed and thoroughly tested software utility using dozens of actual examples.
